(19) United States
(12) Patent Application Publication
(10) Pub. No.: US 2015/0046434 A1
(43) Pub. Date: Feb. 12, 2015

(54) MOBILE DEVICE AND METHOD FOR OFFERING QUERY RECOMMENDATIONS

(71) Applicant: Samsung Electronics Co., Ltd., Suwon-si (KR)

(72) Inventors: Yeunwook LIM, Daegu (KR); Chulhyung YANG, Gumi-si (KR); Yonggil HAN, Gumi-si (KR)

(21) Appl. No.: 14/451,765

(22) Filed: Aug. 5, 2014

(30) Foreign Application Priority Data
Aug. 6, 2013 (KR) 10-2013-0093086

(51) Int. Cl. G06F 17/30; G10L 15/08; H04L 29/08

(52) U.S. Cl. CPC G06F 17/3097; G06F 17/30522; H04L 67/18; G10L 15/08
USPC 707/722

(57) ABSTRACT

A mobile device and a method for offering query recommendations on the basis of a background application are provided. In the method, the mobile device analyzes the background application when a search window is activated. Then the mobile device receives a search query entered in the search window, compares the received search query with information about the analyzed background application, and derives the query recommendations for the received search query, based on a result of the comparing. When a user's input for selecting one of the query recommendations is received, the mobile device displays the selected query recommendation in the search window.

### CROSS-REFERENCE TO RELATED APPLICATION(S)

This application claims the benefit under 35 U.S.C. §119(a) of a Korean patent application filed on Aug. 6, 2013 in the Korean Intellectual Property Office and assigned Serial number 10-2013-0093086, the entire disclosure of which is hereby incorporated by reference.

### TECHNICAL FIELD

The present disclosure relates to technology for offering query recommendations in a mobile device. More particularly, the present disclosure relates to a mobile device and method for offering query recommendations on the basis of a background application which is running when a search query is entered into a search window.

### BACKGROUND

Many electronic devices today, especially mobile devices, support a function to offer auto-complete query recommendations when a user's search query is entered into a search window.

For example, if a map application is currently running, and if a user enters a search query “abc” in a search window, a mobile device may display auto-complete query recommendations “abc mart, abc gallery, abc station”. Then a user can select a desired one of the displayed query recommendations.

This typical technique to offer query recommendations has limitations in that query recommendations are selected among specific words frequently searched by users of a web server. Therefore, a user who desires to find any unusual word is often required to enter full spellings.

Furthermore, even if a user enters a search query while a certain application is running, such a typical technique merely offers restricted query recommendations according to predefined priorities regardless of a background application. Query recommendations are offered without any consideration for the convenience of users.

Accordingly, there is a need for a new technique that has the ability to offer query recommendations on the basis of a background application in a mobile device as well as being based on a web server.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide query recommendations on the basis of a background application in a mobile device when a search query is entered into a search window.

In accordance with an aspect of the present disclosure, a method for offering query recommendations in a mobile device is provided. The method includes analyzing a background application when a search window is activated, receiving a search query entered in the search window, comparing the received search query with information about the analyzed background application, and deriving the query recommendations for the received search query, based on a result of the comparing.

In accordance with another aspect of the present disclosure, a method for offering query recommendations in a mobile device is provided. The method includes analyzing a background application when a voice recognition mode is activated, receiving a voice input as a search query, comparing the received voice input with information about the analyzed background application, and performing voice recognition for the received voice input, based on a result of the comparing.

In accordance with an aspect of the present disclosure, a mobile device for offering query recommendations is provided. The mobile device includes an input unit configured to receive a search query, and a control unit configured to analyze a background application when a search window is activated, to receive the search query entered in the search window from the input unit, to compare the received search query with information about the analyzed background application, and to derive the query recommendations for the received search query, based on a result of the comparing.

In accordance with another aspect of the present invention, a mobile device for offering query recommendations is provided. The mobile device includes an input unit configured to receive a voice input, and a control unit configured to analyze a background application when a voice recognition mode is activated, to receive the voice input as a search query, to compare the received voice input with information about the analyzed background application, and to perform voice recognition for the received voice input, based on a result of the comparing.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows screenshots illustrating a typical search process using a map application according to the related art.

FIG. 2 shows screenshots illustrating a typical process of offering query recommendations for a music title during playback of a music file according to the related art.

FIG. 3 shows screenshots illustrating a method for offering query recommendations on the basis of a background application according to an embodiment of the present disclosure.

FIG. 4 is a block diagram illustrating an internal structure of a mobile device according to an embodiment of the present disclosure.

FIG. 5 is a flow diagram illustrating a method for offering query recommendations for a text query on the basis of a background application according to an embodiment of the present disclosure.

FIG. 6 is a flow diagram illustrating a method for offering query recommendations for a voice query on the basis of a background application according to an embodiment of the present disclosure.

FIG. 7 shows screenshots illustrating a method for offering query recommendations on a map application on the basis of a background chatting application according to an embodiment of the present disclosure.

FIG. 8 shows screenshots illustrating a method for offering query recommendations for a music title on the basis of a background music player application according to an embodiment of the present disclosure.

FIG. 9 shows screenshots illustrating a method for offering query recommendations for a search query on the basis of a background web browser according to an embodiment of the present disclosure.

FIG. 10 shows screenshots illustrating another method for offering query recommendations for a search query on the basis of a background web browser according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a query” includes reference to one or more of such queries.

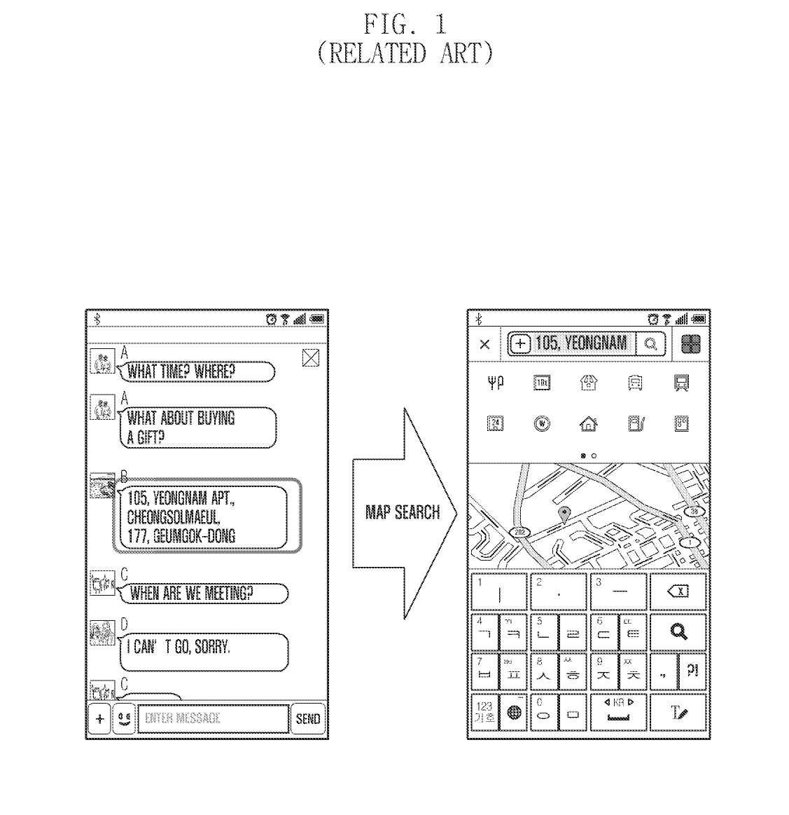

FIG. 1 shows screenshots illustrating a typical search process using a map application according to the related art.

Referring to FIG. 1, a user using a chatting application tries to find a geographical location of a specific address contained in a chatting message through a map application. When the map application is invoked, the chatting application is running in the background.

In this case, the user memorizes an address from a chatting message and then enters its full spellings in a search window of the map application by using a touch keypad, or copies an address from a chatting message and then pastes it in a search window of the map application.

Since an address “105, Yeongnam Apt., Cheongsolmaeul, 177, Geumgok-dong” shown as an example in FIG. 1 is not a widely used query, it is not easy to offer reliable query recommendations. Therefore, full spellings of a query have to be entered for more exact and reliable search.

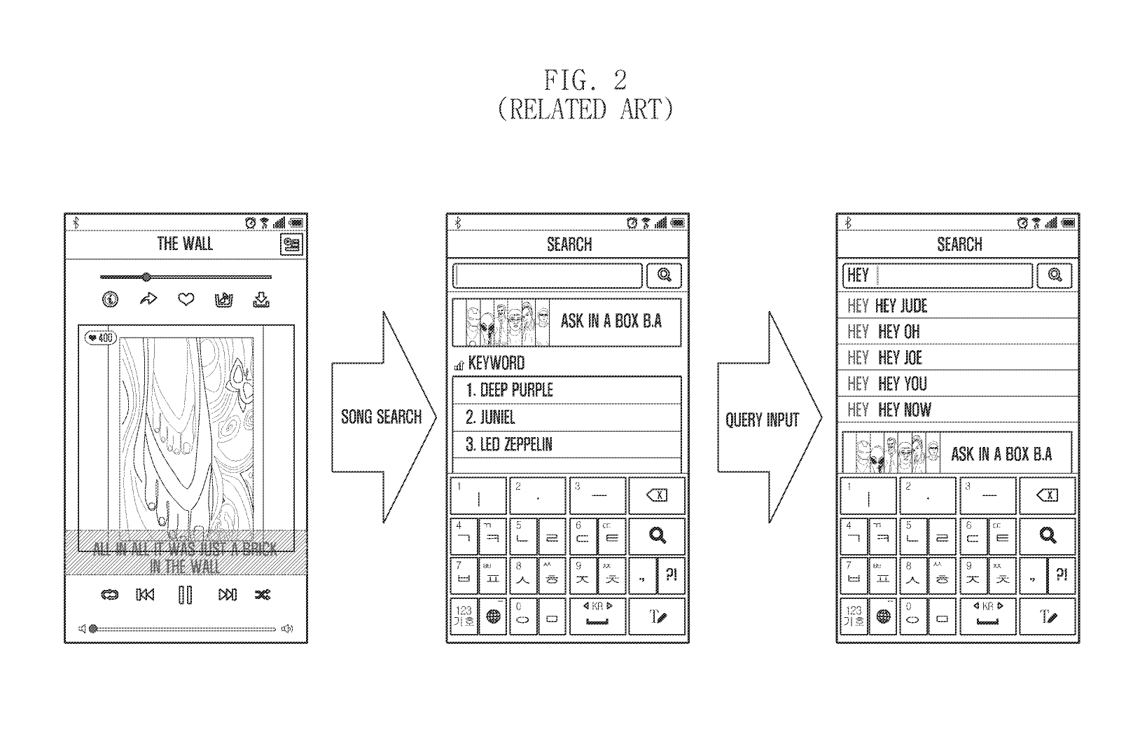

FIG. 2 shows screenshots illustrating a typical process of offering query recommendations for a music title during playback of a music file according to the related art.

Referring to FIG. 2, a user who is listening to a music file “the Wall” of “Pink Floyd” through a music player application tries to find another music file of “Pink Floyd” containing a word “hey” in a song title through a search application. When the search application is invoked, the music player application is running in the background.

In this case, a user enters a search query “hey” in a search window of the search application. Then, according to a typical search process based on a web server, query recommendations such as “Hey Jude, the Beatles” and the like are offered among frequently searched songs that contain a word “hey”.

The typical search process often fails to offer a user's desired query. Accordingly, full spellings of a query have to be entered for more exact and reliable search.

As exemplarily shown in FIGS. 1 and 2, a typical process of offering query recommendations based on a web server may fail to offer a suitable query needed by a user. Accordingly, a process of offering query recommendations on the basis of a background application in a mobile device is required.

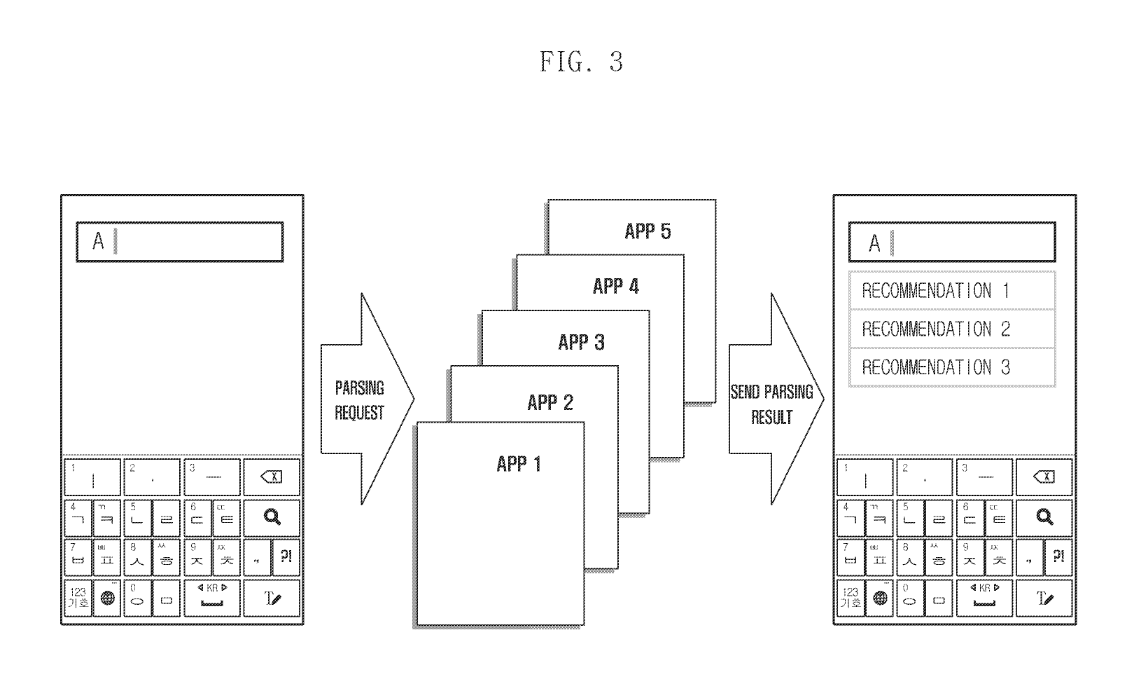

FIG. 3 shows screenshots illustrating a method for offering query recommendations on the basis of a background application according to an embodiment of the present disclosure.

Referring to FIG. 3, when a search query is entered in a search window, the method for offering query recommendations begins with an analysis of a background application.

In the case where five background applications are running, a mobile device performs parsing of text associated with “a” contained in such applications in order to offer query recommendations for a search query “a”. The mobile device interprets five applications by using a compiler or interpreter, and analyzes a grammatical construction or syntax of text.

When a search query is received, the mobile device may offer query recommendations with priorities which are determined in view of the most recent background application and the most recent text.

Detailed cases of offering query recommendations on the basis of a background application are described below.

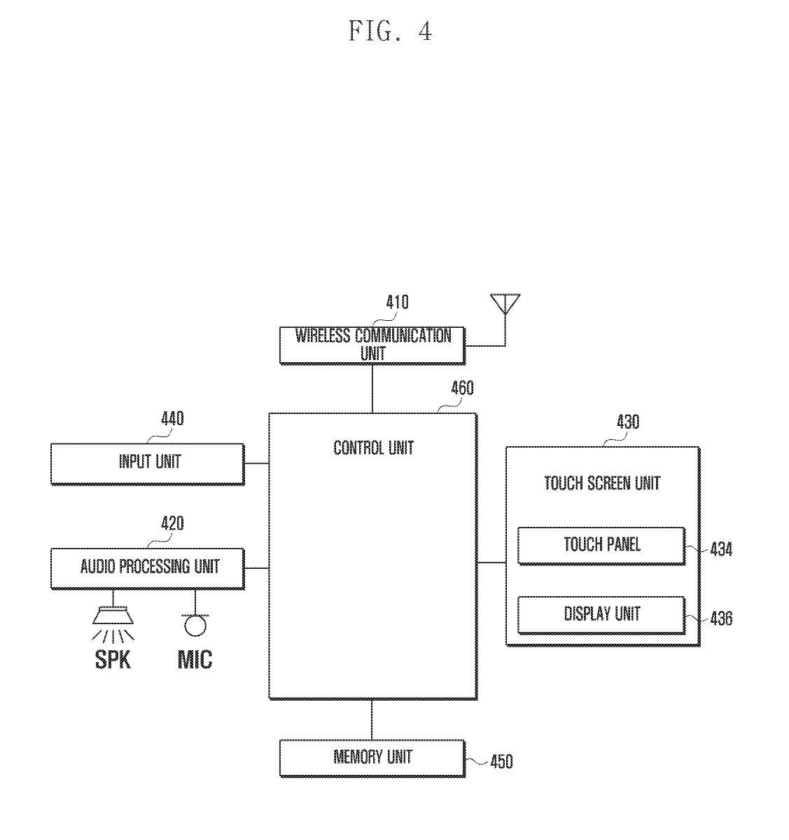

FIG. 4 is a block diagram illustrating an internal structure of a mobile device according to an embodiment of the present disclosure.

Referring to FIG. 4, the mobile device 400 may include, but is not limited to, a wireless communication unit 410, an audio processing unit 420, a touch screen unit 430, an input unit 440, a memory unit 450, and a control unit 460.

The wireless communication unit 410 transmits or receives data for a wireless communication of the mobile terminal 400. The wireless communication unit 410 may include a Radio Frequency (RF) transmitter that up-converts the frequency of an outgoing signal and amplifies the signal, an RF receiver that amplifies with low-noise an incoming signal and down-converts the frequency of the signal, and the like. Additionally, the wireless communication unit 410 may receive data through a wireless channel and transmit the received data to the control unit 460, and also transmit output data of the control unit 460 through a wireless channel. The wireless communication unit 410 may receive information associated with a typical web server-based technique to offer query recommendations.

The audio processing unit 420 includes a Speaker (SPK) for reproducing audio data received during a call, audio data contained in a received message, audio data of an audio file stored in the memory unit 450, and the like, and a Microphone (MIC) for collecting a user's voice during a call or any other audio signal.

Under the control of the control unit 460, the audio processing unit 420 drives the microphone in a voice recognition mode and records a user's voice collected though the microphone. The audio processing unit 420 transmits the recorded voice to the control unit 460 such that voice recognition can be made. In this embodiment, the audio processing unit 420 that performs a voice recognition function may be considered as a type of the input unit 440.

The touch screen unit 430 includes a touch panel 434 and a display unit 436. The touch panel 434 detects a user's touch input. The touch panel 434 may be formed of a touch sensor of a capacitive overlay type, a resistive overlay type, an infrared beam type, etc. or a pressure sensor. Alternatively, any other type of sensor device capable of detecting contact or pressure of an object may be used for the touch panel 434.

The touch panel 434 detects a user's touch input, creates a sensing signal, and transmits the sensing signal to the control unit 460. This sensing signal contains coordinate data of a user's touch input. In case a user takes a touch drag action, the touch panel 434 creates a sensing signal containing coordinate data of a touch drag path and transmits it to the control unit 460.

The touch panel 434 may detect a search query entered by a user. This search query has no need of a complete word or sentence, and just one letter entered in a search window may be enough for a search query according to embodiments of the present disclosure.

The display unit 436 may be formed of Liquid Crystal Display (LCD), Organic Light Emitted Diode (OLED), Active Matrix Organic Light Emitted Diode (AMOLED), or the like. The display unit 436 visually offers a user a variety of information such as a menu of the mobile device 400, any input data, function setting information, and the like. The display unit 436 may display thereon any information indicating the status of the mobile device 400. The display unit 434 displays auto-complete query recommendations. As a result, a user can select one of the displayed query recommendations through the touch panel 434.

Although the mobile device 400 of the present disclosure may include the above-discussed touch screen unit, an embodiment of this disclosure to be described hereinafter is not always applied to only the mobile device 400 having the touch screen unit. In cases where embodiments of the present disclosure are applied to any mobile device having no touch screen, the touch screen unit 430 shown in FIG. 4 may be modified to perform a function of the display unit 436 only. In this case, a similar function to that of the touch panel 434 may be performed by the input unit 440.

The input unit 440 receives a user's key manipulation for controlling the mobile device 400, creates an input signal, and transmits the input signal to the control unit 460. The input unit 440 may be formed of a keypad having alphanumeric keys and navigation keys, and may also include some function keys disposed at sides of the mobile device 400. In case the mobile device 400 receives input solely through the touch screen unit 430, the input unit 440 may be omitted. The input unit 440 may receive a search query from a user.

The memory unit 450 stores programs and data required for the operation of the mobile device 400, and thus may be divided into a program region and a data region.

The program region may store some default programs such as a program for controlling a general operation of the mobile device 400, an Operating System (OS) for booting the mobile device 400, and the like. The program region may store any optional application, selectively installed by a user, e.g., a game application, a social network service application, or the like. The data region may store data created in connection with the use of the mobile device 400 such as image, video, phonebook, audio data, and the like. The memory unit 450 stores at least one background application to be used when query recommendations will be offered.

The control unit 460 controls general operations of respective elements in the mobile device. When a search query is received from either the touch panel 434 or the input unit 440, the control unit 460 controls a sequential process of parsing a current background application, comparing the received search query with parsed information about the current background application, and then, based on a comparison result, deriving query recommendations for the received search query.

Additionally, when a voice recognition mode is activated, the control unit 460 controls a sequential process of parsing a current background application, comparing a user's voice input with parsed information about the current background application, and then, based on a comparison result, recognizing the voice input.

Detailed cases of offering query recommendations on the basis of a background application are described below.

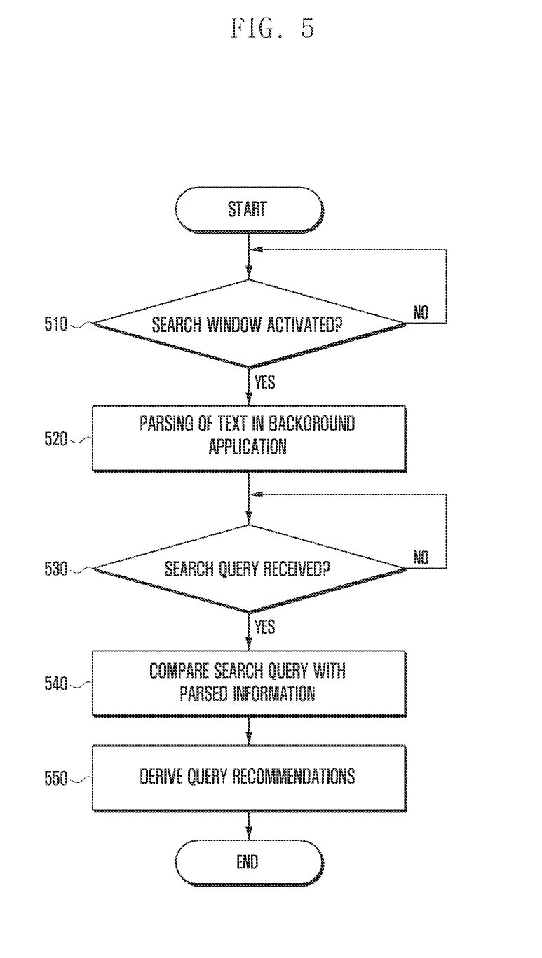

FIG. 5 is a flow diagram illustrating a method for offering query recommendations for a text query on the basis of a background application according to an embodiment of the present disclosure.

Referring to FIG. 5, at operation 510, the display unit 436 activates a search window under the control of the control unit 460. At operation 520, the control unit 460 performs parsing of a background application.

Although the control unit 460 may parse text contained in a background application at operation 520, this is exemplary only and not to be considered as a limitation. The control unit 460 may parse all content of a background application. For example, the control unit 460 may parse non-text information about an album title, a singer name, etc. in case of a music player application.

When a search query is received through the touch pad 434 or the input unit 440 at operation 530, the control unit 460 compares the received search query with the parsed information of a background application at operation 540.

Although FIG. 5 shows that operation 520 is performed before operation 530, this is exemplary only and not to be considered as a limitation. Alternatively, the performance order of these operations may be changed.

At operation 550, the control unit 460 derives query recommendations for the received search query on the basis of the parsed information of a background application, and the display unit 436 displays the query recommendations, such as in the form of a list. Thereafter, if a user input for selecting one of the displayed query recommendations is received through the touch pad 434 or the input unit 440, the control unit 460 may perform a normal search process using the selected query.

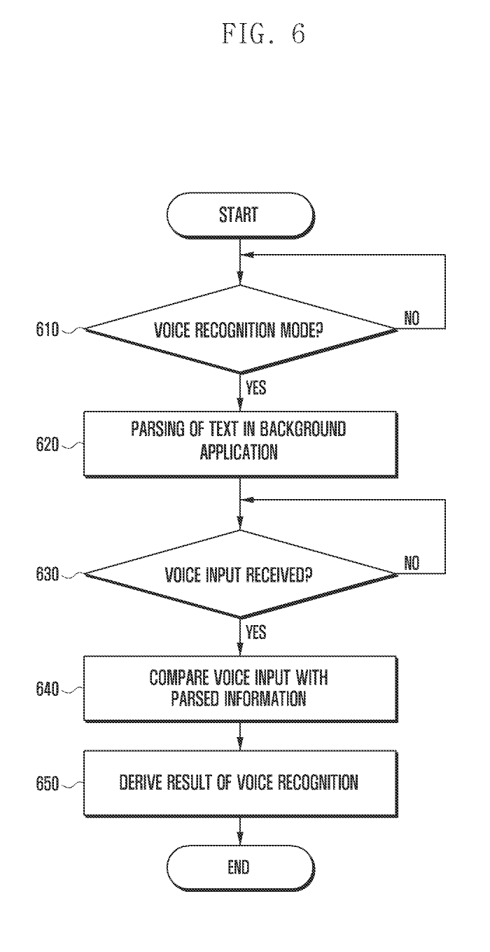

FIG. 6 is a flow diagram illustrating a method for offering query recommendations for a voice query on the basis of a background application according to an embodiment of the present disclosure.

Referring to FIG. 6, at operation 610, the audio processing unit 420 activates a voice recognition mode under the control of the control unit 460.

At operation 620, the control unit 460 performs parsing of a background application. Although the control unit 460 may parse text contained in a background application at operation 620, this is exemplary only and not to be considered as a limitation of this disclosure. Alternatively, the control unit 460 may parse all content of a background application. For example, the control unit 460 may parse non-text information such as image or video information in a photo album application.

When a voice input is received as a search query through the audio processing unit 420 at operation 630, the control unit 460 compares the received voice input with the parsed information of a background application at operation 640.

Although FIG. 6 shows that operation 620 is performed before operation 630, this is exemplary only and not to be considered as a limitation. The performance order of these operations may be changed.

At operation 650, the control unit 460 derives a result of voice recognition on the basis of the parsed information of a background application.

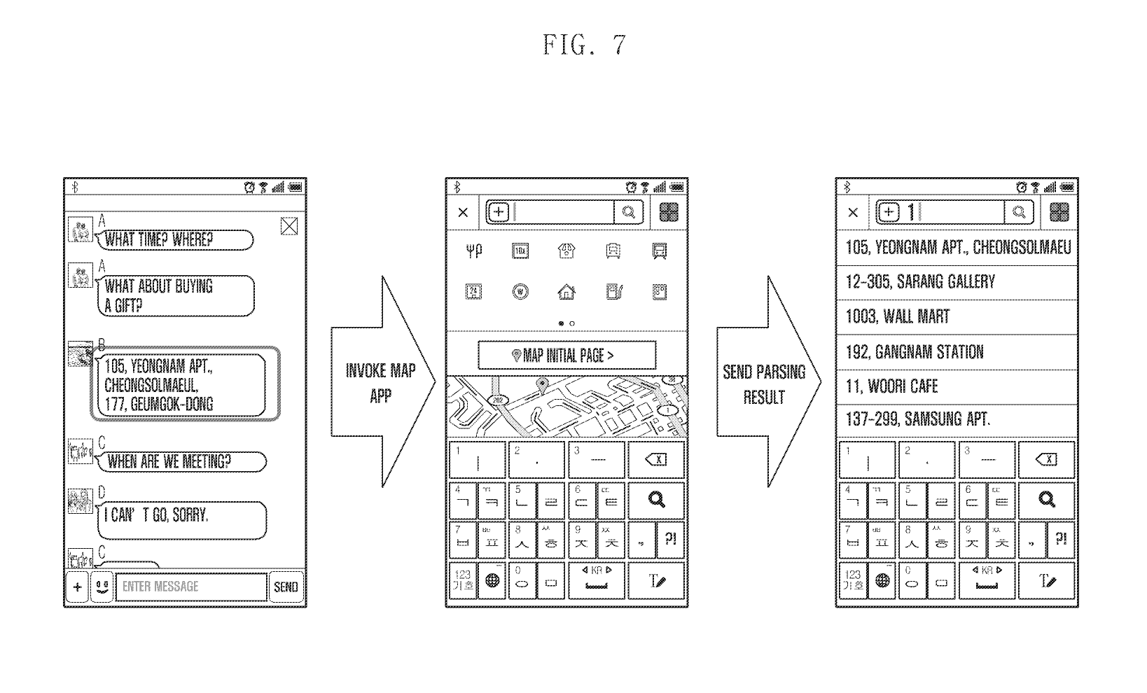

FIG. 7 shows screenshots illustrating a method for offering query recommendations on a map application on the basis of a background chatting application according to an embodiment of the present disclosure.

Referring to FIG. 7, a user who is using a chatting application tries to find a geographical location of a specific address contained in a chatting message through a map application. When the map application is invoked, the chatting application is running in the background.

If a search window of the map application is activated, an address “105, Yeongnam Apt., Cheongsolmaeul, 177, Geumgok-dong” contained in the chatting application is parsed.

Even if a user enters only the initial letter “l” as a part of alphabetic and numeric letters that constitute a desired search query, the parsed address is offered as one of the query recommendations.

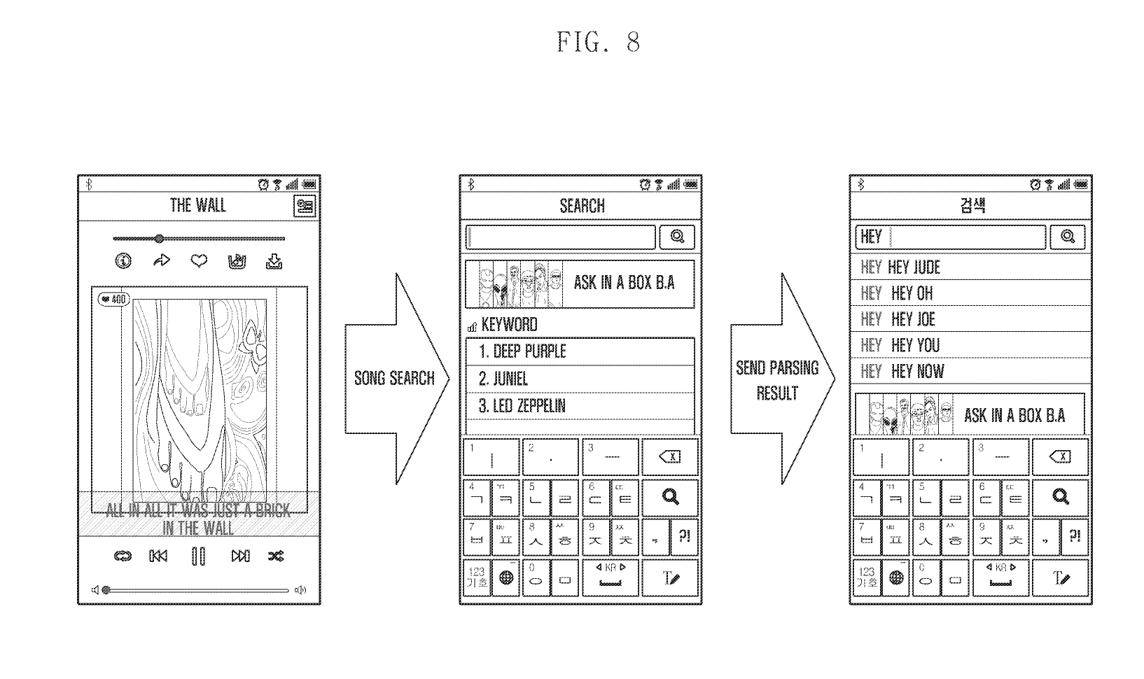

FIG. 8 shows screenshots illustrating a method for offering query recommendations for a music title on the basis of a background music player application in accordance with an embodiment of the present disclosure according to an embodiment of the present disclosure.

Referring to FIG. 8, a user who is listening to a music file “the Wall” of “Pink Floyd” through a music player application tries to find another music file of “Pink Floyd” containing a word “hey” in a song title through a search application. When the search application is invoked, the music player application is running in the background.

If a search window of the search application is activated, a singer name “Pink Floyd” and a song title “the Wall” contained in the music player application are parsed.

Therefore, even if a user enters a search query “hey”, a query recommendation “Hey You, Pink Floyd” is offered with the highest priority.

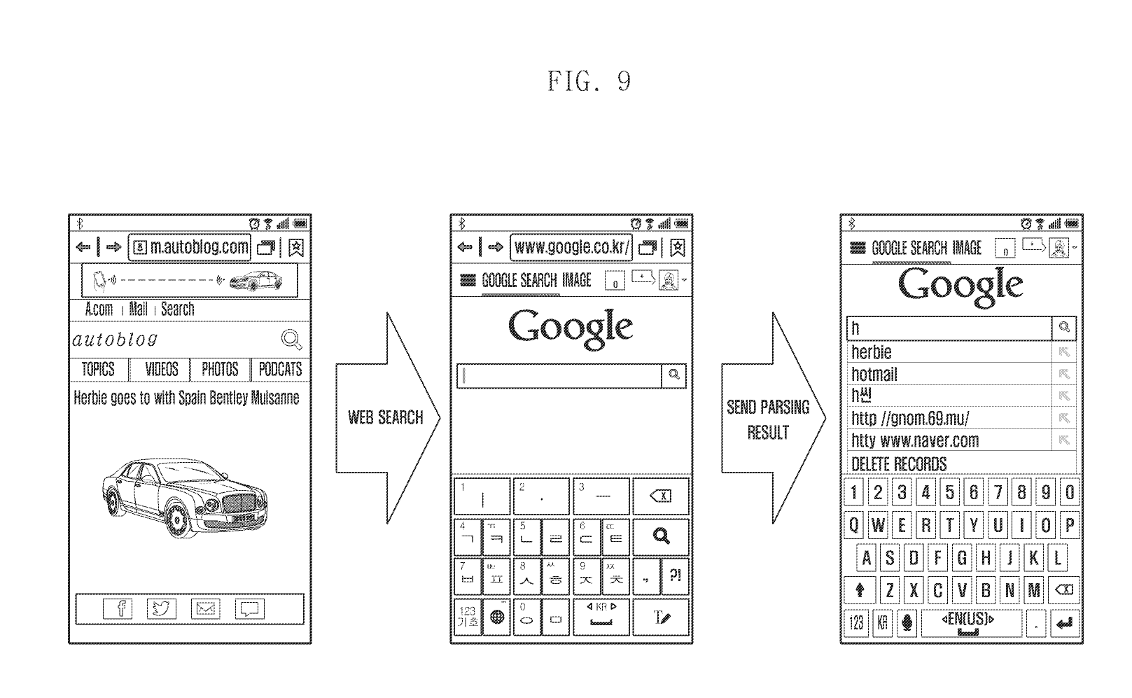

FIG. 9 shows screenshots illustrating a method for offering query recommendations for a search query on the basis of a background web browser according to an embodiment of the present disclosure.

Referring to FIG. 9, a user who is using a web browser opens a web search page so as to search for specific text displayed on the screen. When the web search page is opened, the web browser is running in the background.

If a search window of the web search page is activated, any text “herbie”, “Bentley”, etc. contained in the web browser are parsed.

Therefore, even if a user enters a search query “h”, a query recommendation “herbie” is offered with the highest priority. This is helpful to a case of trying to search many search sites by using only a single search query.

A process of offering query recommendations does not always depend on parsing of text. Alternatively, the mobile device may recognize any image or video displayed on or played in a background application and, based on such an image or video, offer query recommendations.

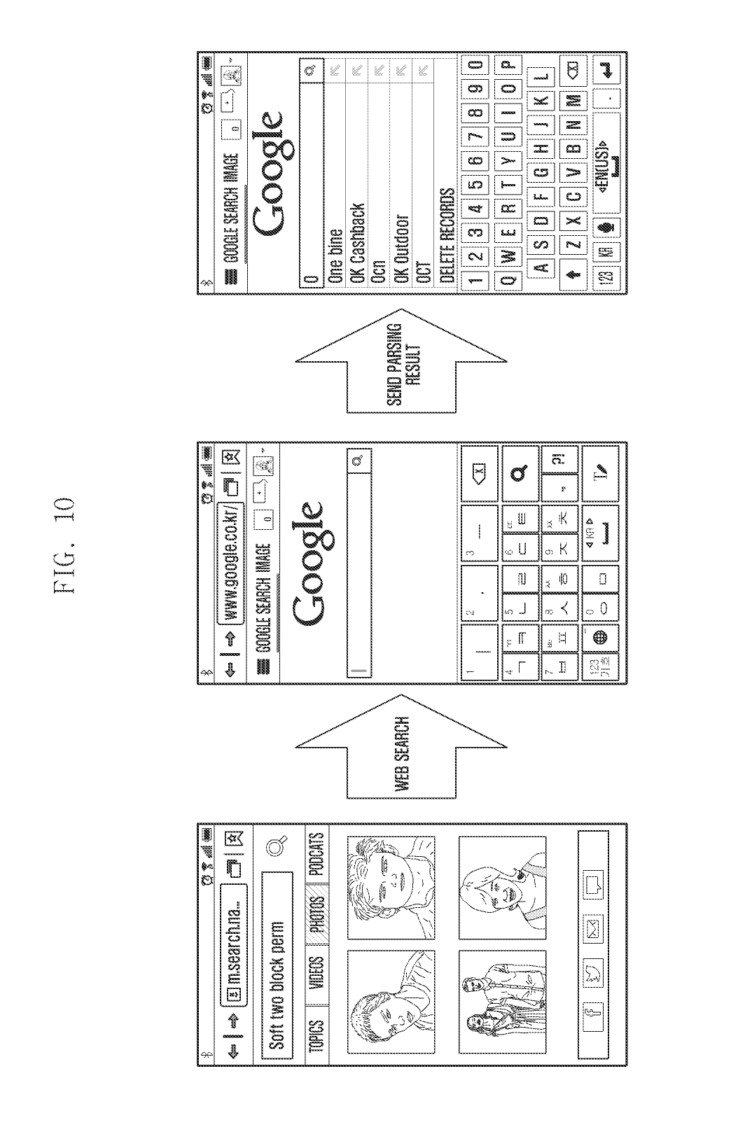

FIG. 10 shows screenshots illustrating another method for offering query recommendations for a search query on the basis of a background web browser according to another embodiment of the present disclosure.

Referring to FIG. 10, a user searches for an image of “soft two block perm” which is a men's hairstyle, a background application may contain some images associated with such a hairstyle. Also, if the hairstyle of One Bine who is a famous actor in Korea is “soft two block perm”, such images may include an image of One Bine.

Therefore, even if a user enters a search query “o” in a search window, the mobile device analyzes image information in the background application and then offers a query recommendation “One Bine” with the highest priority.

Alternatively, if a movie video “RED” is played in a background application, and when a user enters a search query “b” in a search window, the mobile device analyzes movie information in the background application and then offers a query recommendation “Bruce Willis”, who is a hero in the movie “RED”, with the highest priority.

As fully discussed hereinbefore, the mobile device and method disclosed herein may offer query recommendations on the basis of a background application, thus enhancing the convenience of users.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for offering query recommendations in a mobile device, the method comprising:
analyzing a background application when a search window is activated;
receiving a search query entered in the search window;
comparing the received search query with information about the analyzed background application; and
deriving the query recommendations for the received search query, based on a result of the comparing.

2. The method of claim 1, wherein the analyzing of the background application includes analyzing at least one of text, images, and video in the background application.

3. The method of claim 2, further comprising:
displaying the derived query recommendations in a form of a list.

4. The method of claim 3, wherein the comparing of the received search query with the information includes comparing an initial part of the received search query with the information about the analyzed background application.

5. The method of claim 4, further comprising:
receiving a user's input for selecting one of the query recommendations displayed in the form of the list; and
displaying the selected query recommendation in the search window.

6. A method for offering query recommendations in a mobile device, the method comprising:
analyzing a background application when a voice recognition mode is activated;
receiving a voice input as a search query;
comparing the received voice input with information about the analyzed background application; and
performing voice recognition for the received voice input, based on a result of the comparing.

7. A mobile device for offering query recommendations, the mobile device comprising:
an input unit configured to receive a search query; and
a control unit configured to analyze a background application when a search window is activated, to receive the search query entered in the search window from the input unit, to compare the received search query with information about the analyzed background application, and to derive the query recommendations for the received search query, based on a result of the comparing.

8. The mobile device of claim 7, wherein the control unit is further configured to analyze at least one of text, image and video in the background application.

9. The mobile device of claim 8, wherein the control unit is further configured to control a display of the derived query recommendations in a form of a list.

10. The mobile device of claim 9, wherein the control unit is further configured to compare an initial part of the received search query with the information about the analyzed background application.

11. The mobile device of claim 10, wherein the control unit is further configured to receive a user's input for selecting one of the query recommendations displayed in the list, and to control a display of the selected query recommendation in the search window.

12. A mobile device for offering query recommendations, the mobile device comprising:
an input unit configured to receive a voice input; and
a control unit configured to analyze a background application when a voice recognition mode is activated, to receive the voice input as a search query, to compare the received voice input with information about the analyzed background application, and to perform voice recognition for the received voice input, based on a result of the comparing.

13. A non-transitory computer-readable storage medium storing instructions that, when executed, cause at least one processor to perform the method of claim 1.

14. A non-transitory computer-readable storage medium storing instructions that, when executed, cause at least one processor to perform the method of claim 6.
